(19) United States
(12) Patent Application Publication
(10) Pub. No.: US 2009/0134677 A1
(43) Pub. Date: May 28, 2009

(54) Motor Vehicle Seat with an Air Supply Device

(75) Inventors: Peter Maly, Stuttgart (DE); Karl Pfahler, Stuttgart (DE); Lothar Renner, Nufringen (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 11/996,942

(22) PCT Filed: Jul. 26, 2006
(86) PCT No.: PCT/EP06/07352

§ 371 Date: Jul. 11, 2008

(30) Foreign Application Priority Data
Jul. 27, 2005 (DE) 10 2005 035 113.1

(51) Int. Cl. B60N 2/56; A47C 7/74

(52) U.S. Cl. 297/180.14; 297/180.13

(57) ABSTRACT

In a motor vehicle seat for a closed motor vehicle, an air supply device is provided for supplying the head, neck and shoulder region of the seat occupant with warm air that can emerge via an air discharge opening on that side of the backrest which faces the seat occupant. In order to surround the head, neck and shoulder region of the seat occupant with a draft-free and inconspicuous air cushion or air space, an air discharge opening that extends at least over approximately one third of the width of the backrest of the vehicle seat is provided.

### BACKGROUND AND SUMMARY OF THE INVENTION

This invention relates to a motor vehicle seat for a closed motor vehicle, with an air supply device for supplying the head, neck and shoulder region of a seat occupant with warm air.

An air supply device in a motor vehicle seat is already known from German document DE 100 47 754 B4, but this air supply device is particularly suitable for an open motor vehicle. That air supply device has an air discharge opening which is provided on that side of the seat which faces the seat occupant, via which opening a warm air flow for supplying the head, neck and shoulder region of the seat occupant can emerge. In the case of open travel, the air flowing over or around the windshield produces, as is known, an “air roll” in the region behind the vehicle seats, the air roll leading to undesirable drafts in the region of the head, neck and shoulder region of the seat occupant. In order to significantly minimize these drafts, the warm air flow generated by the air supply device has to be directed to the appropriate body region of the seat occupant to a corresponding degree and in a very accurately focused manner by way of a nozzle of the air discharge opening. The warm air then flows around the seat occupant at a relatively high velocity in order to achieve the desired warming of the head, neck and shoulder region.

It is the object of the present invention to design an air supply device for a motor vehicle seat, which can be used in particular for a closed motor vehicle.

This object is achieved according to the invention by a motor vehicle seat with the features claimed. Advantageous refinements and expedient, non-trivial developments of the invention are also claimed.

In a motor vehicle seat according to the invention, an air supply device is provided with an air discharge opening that extends at least over approximately one third of the width of the vehicle seat. In the air supply device according to the prior art of German document DE 100 47 754 B4—as described above—a very powerful, warm air flow is necessary in order to reduce the undesirable drafts during open driving. In the present case, an air supply device is to be provided, in which the head, neck and shoulder region of the seat occupant is to be surrounded with a warm air space. In other words, the discussed body region of the seat occupant is not to be exposed to a powerful air flow, but rather is to be surrounded by a relatively inconspicuous and unobtrusive virtual air cushion causing little draft. For the above-described reasons, it is therefore necessary that the preferably warm air—when there is an appropriate quantity of air—can be discharged from the air supply device in the direction of the vehicle occupant at relatively low velocities. Accordingly, in order to achieve this, a relatively large opening cross section of the air discharge opening, which cross section extends at least over approximately one third of the width of the vehicle seat, is necessary. In addition, the effect which can be achieved by this large air discharge opening is that a constant and homogeneous distribution of temperature is produced within the discharging warm air. In addition, an air discharge opening constructed to be of such a width has the advantage that a very wide region in the vicinity of the head, neck and shoulder region of the seat occupant can be supplied with air.

In this case, the opening cross section of the air outlet opening can be approximately rectangular, with a longitudinal side extending over at least one third, preferably over more than half, of the width of the seat and with a narrower transverse side. The air outlet opening can be covered by a grill or upholstery fabric with a plurality of small openings, preferably perforated upholstery fabric, and therefore a diffuse air flow is produced in the outlet region of the air outlet opening.

Whereas the central, lower region of the backrest between the side cheeks, which is referred to in specialist terminology as the seat area and with which the seat occupant is in direct body contact, is generally supplied by a seat heating system with resistance wires, according to the previous prior art that part of the backrest which is arranged above the seat area and is adjacent to the head, neck and shoulder region of the seat occupant remains largely cold. This problem is remedied in accordance with the principle now present in accordance with the invention, and the cold radiated by that part of the backrest which is arranged above the seat area is no longer noticed by the seat occupant. This results in a way of enlarging the region of the backrest which is heated by a seat heating system.

In addition to the use for warming the head, neck and shoulder region of the seat occupant, the air supply device according to the invention is also suitable for cooling that body region. In this case, rather than being assigned a heating element (also described below), the air supply device is assigned a cooling element. When there are warm temperatures in the interior of the motor vehicle and a backrest which is accordingly also warm, the air supply device according to the invention can ensure a pleasant coolness in the body region discussed without an unpleasant, cold draft being perceived. On the contrary, a cool air cushion can then also be provided, and is perceived by the seat occupant as being extremely pleasant. Whereas, in the lower seat area region of the backrest, in which the seat occupant is in direct contact with the upholstery of the backrest, a “seat ventilation means”, as described, for example, in German document DE 196 28 698 C1, takes on the cooling function, a region of the backrest above the seat area can now also be correspondingly cooled.

A particularly homogeneous and extensive air cushion can be achieved in the region of the head, neck and shoulder region of the seat occupant—even when different seat occupants have different heights—if the air discharge opening is of correspondingly large design and extends at least over the width of the seat area of the backrest. Accordingly, the air discharge opening preferably extends at least over approximately half of the width of the vehicle seat.

The arrangement of the air discharge opening on the front side, which faces the seat occupant, and in the vicinity of the upper end side of the backrest has proven particularly advantageous. However, it would likewise also be conceivable to arrange the air supply device within the head restraint of the backrest. Accordingly, for the arrangement of the air discharge opening, virtually any backrest region which lies opposite the head, neck and shoulder region of the seat occupant and in which the seat occupant does not make direct contact with the backrest and therefore closes the air discharge opening is conceivable.

The air supply device is preferably designed as a preassembled installation module which can then be integrated in the backrest, for example by being fastened to the backrest frame or else within the head restraint.

As already explained above, the air supply device can be used both for warming and for cooling the head, neck and shoulder region of the seat occupant. Accordingly, the ventilation apparatus provided is a heating and/or cooling device for warming or cooling the air cushion.

In the case of the heating and/or cooling device, the air-throughflow layer is provided with a structure by means of which the entering air flow can be converted into a turbulent or diffuse flow. Such a turbulent or diffuse flow has the advantage that it can absorb far more heat or cold than laminar air. In contrast to a laminar flow, in the present case, not only are the boundary layers coming directly into contact with a corrugated rib heated/cooled, but also a much larger air fraction is heated/cooled. Furthermore, the turbulent or diffuse flow generated causes the air flow to remain for longer in the air-throughflow layer, and therefore more heat or cold can be absorbed.

The turbulent or diffuse flow of the air flow is achieved in that the structure of the air-throughflow layer comprises a multiplicity of spacer threads, spacer webs, spacer wires or the like. A conceivable configuration of the air-throughflow layer is known, for example, from German document DE 198 05 178 C2 which relates to a knitted spacer structure in a ventilated vehicle seat and to the contents of which reference is hereby expressly made. The knitted spacer structure described there comprises a multiplicity of spacer webs or spacer threads which run transversely with respect to the outer wide sides of the knitted spacer structure and around which a turbulent of diffuse air flow can flow. The spacer webs or spacer threads in this case are arranged with respect to one another in specific patterns by which the flow direction and flow velocity can be influenced. In this respect, it may be noted that the spacer webs or spacer threads may have the most diverse possible cross-sectional shapes, such as, for example, circular, oval, rectangular, square or the like. The spacer webs or spacer threads in this case may be oriented or unorientated with respect to one another and may be composed of the most diverse possible materials. It has proven particularly advantageous to design the spacer webs or spacer threads as a knitted structure, woven structure or braided structure. However, it is nevertheless conceivable for the spacer threads or spacer webs to have an unorientated arrangement in the manner of a wool. It is clear that such a knitted structure, woven structure or braided structure also has, as compared with the prior art, a far larger flow-around surface for the discharge of heat/cold to the air flowing through.

In addition, it has been shown to be of a particular advantage to produce the structure of the air-throughflow layer from a readily conductive metal, such as, for example, an aluminum or copper alloy. Accordingly, metal threads of this type are particularly suitable for discharging heat or cold to the air flowing around. Thus, owing to the large flow-around surface of the multiplicity of spacer threads, spacer wires or spacer webs, a highly effective heating and/or cooling device can be provided.

In addition, a structure as described, including spacer webs, spacer wires or spacer threads, has the advantage that it can be designed so as to be elastically resilient. It is thereby possible to adapt the air-throughflow layer or the overall sandwich comprising a heating and/or cooling layer and an air-throughflow layer in a correspondingly simple manner to the construction space within which the heating and/or cooling device or the entire air supply device is to be arranged. It has shown to be particularly advantageous to design the heating layer as resistance heating in the form of a thin-layered, deformable and preferably elastic ply. In this case, such a thin-layered, deformable and preferably elastic cooling layer is also conceivable.

The heating layer can have a particularly high heating power and the cooling layer a particularly great cooling power if the heating layer/cooling layer is assigned a readily heat-conductive or cold-conductive covering layer by means of which the heat/cold generated is distributed uniformly within the heating or cooling layer. In particular, a metal foil or a metal sheet composed, for example, of an aluminum or copper alloy has proven suitable in this connection.

A particularly effective sandwich of the heating and/or cooling device is provided when at least three air-throughflow layers are provided, with a heating or cooling layer being arranged in each case between the middle and the outer air-throughflow layers. The central middle air-throughflow layer is thus supplied with heat and/or cold by the two heating or cooling layers flanking it, and therefore the air flow flowing through the middle layer can be heated or cooled particularly quickly. The two outer air-throughflow layers are accordingly supplied with heat or cold only from the adjacent heating or cooling layer, and therefore a lower warming or cooling of the air flow flowing through them occurs in this region. This ensures, inter alia, that there is no overheating of the components surrounding said sandwich, such as, for example, a housing or further parts adjacent thereto.

In addition, with a plurality of layers combined into a sandwich, their flow resistance may be configured differently by, for example, the distance between and orientation of the individual spacer webs, spacer wires or spacer threads of each layer differing. Thus, for example, the effect which can be achieved by a correspondingly finer-mesh knitted structure or woven structure or the like of the middle of the three air-throughflow layers is that the air flow flowing through them remains there longer than in the two outer layers. This gives rise, as a result, to a correspondingly better warming or cooling of the air flow flowing through.

In the simplest embodiment, the sandwich comprising the heating or cooling layer and the air-throughflow layer has a planar configuration. In this case, the number of air-throughflow layers and of the heating layer or cooling layer arranged in between can be selected or expanded as desired. The external dimensions of the sandwich can also be configured as desired. Furthermore, the sandwich comprising the air-throughflow layer and the heating or cooling layer may also be of essentially worm-shaped design and designed to be expandable, in cross section, to any desired diameter.

In a further preferred embodiment, a centrally arranged air-throughflow layer is surrounded circumferentially by a heating layer. This results in a particularly rapid and homogeneous heating or cooling of the air flow flowing through. In this case, a further air-throughflow layer may be provided on the circumference of the heating layer, in which case, in a preferred embodiment, the air flow flowing through the central layer is heated or cooled to a greater extent than the air flow flowing through the layer arranged circumferentially. This design permits an air flow which can be heated or cooled very quickly and sharply in the central air-throughflow layer, whereas the air flow passing through the outer air-throughflow layer arranged circumferentially has a lower or higher temperature, and, accordingly, adjacent components, such as, for example, a housing wall, cannot be overheated or cooled too severely. It is clear that such a centrically constructed arrangement of air-throughflow layers, with, if appropriate, heating or cooling layers arranged in between, can be expanded as desired. Furthermore, circular, oval, or similar arrangements of the heating or cooling layers are also conceivable.

The air supply device preferably comprises a blower which is arranged—as seen in the width direction of the vehicle seat, approximately in the middle of the heating and/or cooling device and which is preferably arranged on the rear side of the heating and/or cooling device, which side faces away from the front side of the seat. In combination with the previously described heating and/or cooling layer, a very space-saving air supply device is therefore provided which can easily be adapted to the depth or thickness of the backrest. In a preferred embodiment, the blower is adapted in its thickness to the thickness of the heating and/or cooling device, and therefore, overall, a very shallow construction of the air supply device can be realized.

In addition, a particularly space-saving construction of the air supply device can be realized if the heating and/or cooling device is enlarged or expanded in an approximately V-shaped manner from a blower as far as the air discharge opening.

Finally, it has proven particularly advantageous to provide the air discharge opening with an outlet grill or an outlet net or the like. This enables the air flow passing out of the heating and/or cooling device to be further retarded and at the same time homogenized, and therefore the desired air cushion which causes little draft is produced around the head, neck and shoulder region of the seat occupant.

Further advantages, features and details of the invention will emerge from the description below of preferred exemplary embodiments and with reference to the drawings.

### BRIEF DESCRIPTION OF THE DRAWINGS

FIG. 1 shows a schematic side view of the motor vehicle seat according to the invention, which seat is arranged within the interior of a motor vehicle and is occupied by a seat occupant;

FIG. 2 shows a schematic perspective view of the heating and/or cooling device and the blower of the air supply device within the motor vehicle seat;

FIG. 3 shows a schematic sectional view of the heating and/or cooling device of the air supply device according to a first embodiment, in which two heating or cooling layers are arranged between three air-throughflow layers;

FIG. 4 shows a schematic sectional view of the heating and/or cooling device of the air supply device according to a further embodiment, in which a plurality, which can be expanded as desired, of air-throughflow layers are separated from one another by a respective heating or cooling layer;

FIG. 5 shows a schematic perspective view of the heating and/or cooling device according to a third embodiment, in which the sandwich comprising the air-throughflow layer and the heating and/or cooling layer is wound essentially in the manner of a worm and is arranged within an air duct;

FIGS. 6a and 6b show a schematic cross section through the heating and/or cooling device according to fourth and fifth embodiments, in which a central air-throughflow layer is surrounded circumferentially by a heating or cooling layer and by a further air-throughflow layer;

FIGS. 7a and 7b show respectively a top view and a sectional view along the line VIIb-VIIb in FIG. 7a through the structure of the air-throughflow layer according to a first embodiment;

FIGS. 8a and 8b show respectively a top view and a sectional view along the line VIIIb-VIIIb in FIG. 8a through the structure of the air-throughflow layer according to a second embodiment;

FIGS. 9a and 9b show respectively a schematic top view and a schematic sectional view along the line IXb-IXb in FIG. 9a through the structure of the air-throughflow layer according to a third embodiment,

FIG. 10 shows a schematic plan view of the structure of the air-throughflow layer according to a fourth embodiment;

FIGS. 11a and 11b show respectively a schematic top view and a sectional view along the line XIb-XIb in FIG. 11a through the structure of the air-throughflow layer according to a fifth embodiment;

FIG. 12 shows a schematic perspective illustration of the upper region of the backrest with the head restraint of the motor vehicle seat, in which region the air supply device according to the invention is integrated;

FIGS. 13a and 13b show respectively a schematic perspective illustration and a schematic sectional illustration along the line XIIb-XIIIb in FIG. 13a through the upper region of the backrest with the air supply device integrated therein;

FIGS. 14a and 14b show respectively a schematic perspective view and a schematic sectional view along the line XIVb-XIVb in FIG. 14a through the backrest with the air supply device integrated therein according to a further embodiment;

FIG. 15 shows a schematic perspective view of the air supply device, which is integrated within the backrest of the motor vehicle seat, according to a further embodiment; and

FIG. 16 shows a schematic perspective view of the backrest with the air supply device, which is integrated therein, according to a further embodiment of the invention.

### DETAILED DESCRIPTION OF THE INVENTION

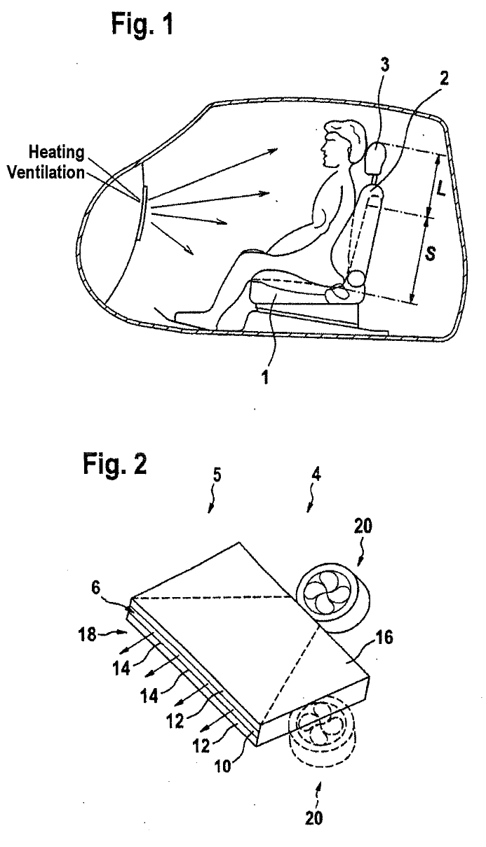

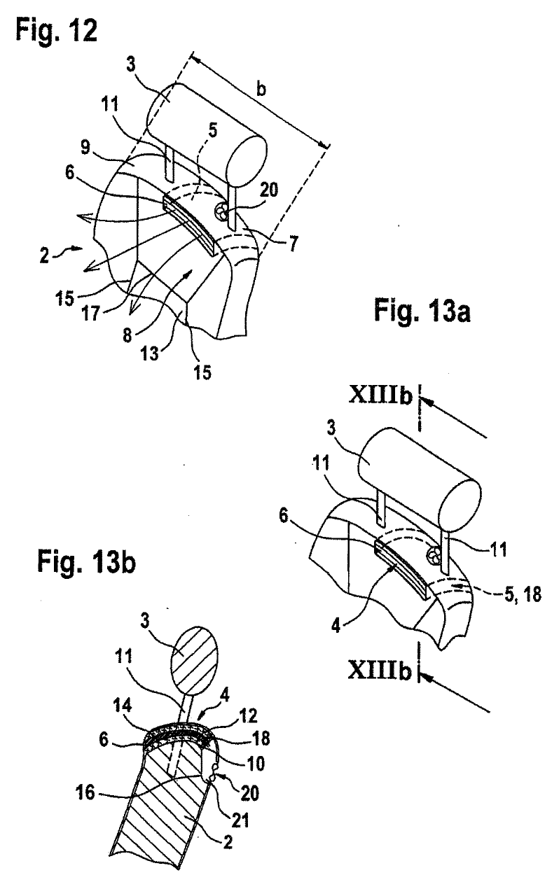

FIG. 1 illustrates, in a schematic side view, part of the interior of a motor vehicle, within which a motor vehicle seat is arranged. The motor vehicle seat essentially comprises a seat part 1 and a backrest 2 which is assigned a head restraint 3. For air conditioning purposes, a heating or air conditioning system is provided in the interior of the motor vehicle and can be used to essentially determine the room temperature of the interior. Furthermore, most motor vehicle seats are provided with a seat heating system in which a multiplicity of resistant wires is arranged below the seat cover. These seat heating systems are customary both in the seat part 1 and in the backrest 2. Within the backrest 2, however, such seat heating systems only extend in a central seat area region 13 (FIG. 12) up to a height S to which the seat occupant is usually in contact with the cushion surface. The head, neck and shoulder region L of the seat occupant, which region is to be surrounded by means of the air supply device according to the invention with a warmed or cooled air space or air cushion, extends above the height S to which the seat occupant is in direct with the backrest 2. The motor vehicle seat with the air supply device is suitable in particular for a closed motor vehicle.

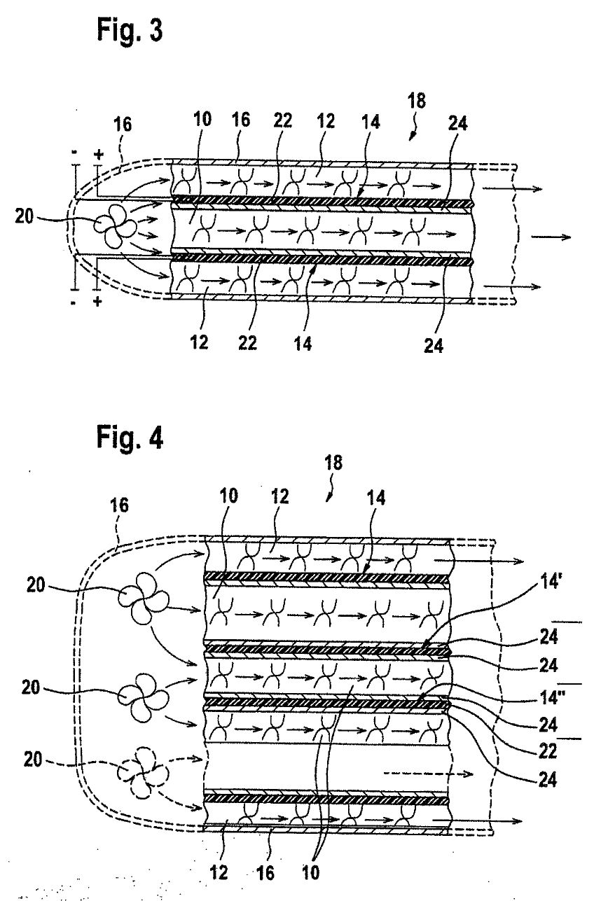

FIG. 2 illustrates, in a schematic perspective illustration of an air supply device 4, a heating and/or cooling device 5 which has yet to be described in more detail below, and an associated blower 20, the function of which will also be explained in more detail below. The heating and/or cooling device 5 comprises a sandwich 18, which has yet to be explained in more detail in particular with reference to FIGS. 3 and 4, comprising air-throughflow layers 10, 12 and heating and/or cooling layers 14 arranged in between, the sandwich 18 being arranged in its entirety within a module housing 16 which is only illustrated schematically and partially. The blower 20 is also arranged within the module housing 16 and is used to suck up air, in particular from a region behind the vehicle seat, and to convey it through the sandwich 18 in a manner yet to be described in more detail below. In the present exemplary embodiment, the heating and/or cooling device 5 and/or the sandwich 18 and the housing 16 are of approximately rectangular configuration. As indicated by the dashed lines, the heating and/or cooling device 5 and/or the sandwich 18 arranged therein and the housing 16 surrounding that device can be enlarged in an approximately V-shaped manner from the blower 20 as far as the air discharge opening 6. Instead of being arranged on the longitudinal side of the heating and/or cooling device 5, the blower 20, which is configured in the present exemplary embodiment as a radial fan, may also be arranged on the narrow side of the heating and/or cooling device 5. This embodiment is indicated by dashed lines. Of course, instead of a radial fan, other customary blowers, such as axial fans or cross flow blowers are also conceivable.

FIG. 3 shows, in a schematic sectional illustration, the heating and/or cooling device 5, which is configured here only as a heating device 5, in which a middle air-throughflow layer 10, two outer air-throughflow layers 12 and two heating layers 14 (described in more detail below) are combined to form the sandwich 18. Instead of or in addition to the heating layers 14, use can also be made of similarly configured cooling layers in order to realize a cooling function of the air supply device 4 in addition to the heating function. The module housing 16, which is provided in the present exemplary embodiment, for receiving the sandwich 18, which module housing serves as an air duct, is produced, for example, from a customary plastic. The blower 20, of which only a schematically indicated blower wheel can be seen in FIG. 1, is connected upstream of the sandwich 18 within the housing 16. By means of the blower 20, an air flow can be generated which, in the present exemplary embodiment, can flow through the three air-throughflow layers 10, 12. The heating layer 14 arranged between the middle air-throughflow layer 10 and the respectively assigned outer air-throughflow layer 12 comprises in each case resistance heating systems which can be supplied with electric current, and, in the present case, is designed as a thin-layered, deformable and elastic ply 22. A ply designed as a cooling layer could be configured in a similar manner. The two heating layers 14 are each assigned a readily heat-conductive covering layer 24 which, in each case, adjoins the wide side of the middle air-throughflow layer 10 and, in the exemplary embodiment shown, is produced from a readily heat-conductive metal foil or metal sheet, in particular composed of an aluminum or copper alloy. In the present exemplary embodiment, all of the layers 10, 12, 14, 22 and 24 are designed in planar form so as to bear closely against one another.

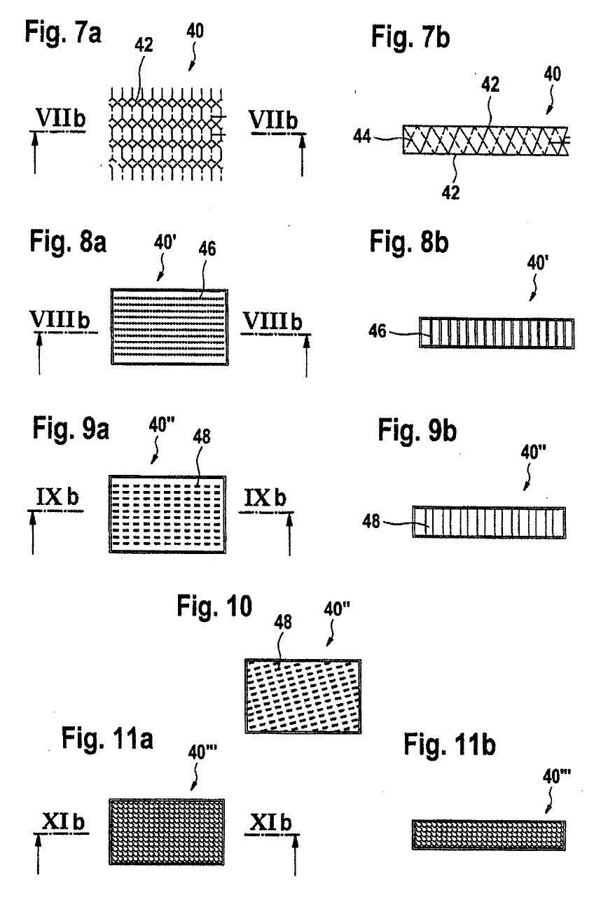

If the blower 20 mounted upstream of the sandwich 18 generates an air flow, the latter passes via the respective narrow side into the middle air-throughflow layer 10 and into the two outer air-throughflow layers 12. In the present exemplary embodiment, the three air-throughflow layers 10, 12 are produced from a knitted spacer structure, which is described in more detail below with reference to FIGS. 7a and 7b and which comprises a multiplicity of spacer threads or spacer webs. The spacer threads or spacer webs in this case run essentially transversely with respect to the direction of flow of the air flow or transversely with respect to the wide sides of the air-through layers 10, 12. Of course, instead of a knitted spacer structure of this type, a woven structure, braided structure or a wool-like structure produced from a multiplicity of spacer threads or the like may also be used. In other words, the spacer webs or spacer threads may either be oriented with respect to one another, or else—as is customary with wool—be arranged in a disordered manner with respect to one another. Accordingly, an air flow generated by the blower 20 is deflected correspondingly frequently at the spacer threads or spacer webs as it flows through the respective air-throughflow layer 10, 12 and, even after a short distance, a turbulent, diffuse flow is established within the respective air-throughflow layer 10, 12. In comparison to a laminar flow, this diffuse flow generated by means of the spacer threads or spacer webs remains for longer within the associated air-throughflow layer 10, 12 and, accordingly, can absorb more heat (or cold in the case of a cooling layer 14) via the heating element 14—which comprises the resistance heating ply 22 and the covering layer 24. In addition, the diffuse distribution of the air flow within the respective air-throughflow layer 10, 12 has the effect that not only do individual boundary layers come into contact with the heating layer 14, but, in addition, a good and homogeneous intermixing of the air flow is achieved.

Since the middle air-throughflow layer 10 is delimited on its two wide sides by a respective heating layer 14 or a covering layer 24, the air flow passing through the middle air-throughflow layer 10 is heated to a particularly great extent (or cooled in the case of a cooling layer 14). Since the two outer air-throughflow layers 12 in each case come into contact only on their wide side facing the middle layer 10 with the heating layer 14 or its resistance heating ply 22, the two air flows passing through the outer air-throughflow layer 12 in each case are heated to a lesser extent (or cooled to a lesser extent in the case of a cooling layer 14) than the air flow passing through the middle air-throughflow layer 10. This ensures, inter alia, that the wall of the housing 16 cannot be overheated due to high temperatures of the air flows passing through the outer air-throughflow layers 12. In other words, the two part air flows flowing through the outer air-throughflow layers 12 act as a kind of heat insulator for the central, warmer part air flow.

In the present exemplary embodiment, the middle air-throughflow layer 10 also has a higher flow resistance than the two outer air-throughflow layers 12 flanking it. The higher flow resistance is obtained by having the spacer threads or the spacer webs of the middle air-throughflow layer 10 arranged closer to one another so that the knitted structure or woven structure has, overall, a closer mesh or denser configuration than the structure of the two outer air-throughflow layers 12. The effect achieved by this is that—with the entry velocity of all of the air flows on the entry side of the air-throughflow layers 10, 12 being the same—that the part air flow through the middle layer 10 flows through the latter more slowly than the two part air flows which pass through the two outer layers 12. Accordingly, by virtue of different velocities, a greater or lesser amount of heat (or cold in the case of a cooling layer 14) can be absorbed by the individual air flows. Furthermore, on the outlet side, a possibly desired layering of the overall air flow can be achieved, namely with a middle warmer air flow from the middle layer 10 and two outer, somewhat less warm air flows from the outer layers 12.

FIG. 4 shows, in a schematic sectional view, the heating device 5 according to a second embodiment, in which the sandwich 18 comprises a plurality of air-throughflow layers 10, 12 and heating layers 14. As indicated by dashed lines, the sandwich 18 in this case can be supplemented by one or more middle air-throughflow layers 10 and can therefore have a variable thickness. Three middle air-routing layers 10 and, on the outside, in each case an outer air-throughflow layer 12 are arranged in the embodiment shown here, with at least one heating and/or cooling layer 14 being provided in each case between the individual air-throughflow layers 10, 12. The sandwich 24 in this case is once again arranged within a housing 16 and, in the present exemplary embodiment, connected downstream of a plurality of blowers 20. Whereas, in FIG. 4, the uppermost heating layer 14 is identical to the uppermost heating layers 14 according to FIG. 3, the heating layers 14′, 14″ which are second from the top and third from the top, as seen from above, each have a different design. In the case of the heating layer 14′ second from the top, a covering layer 24 is provided in each case directly adjacent to the middle air-throughflow layer 10 lying above it and below it and once again is produced from a readily heat-conductive metal sheet or a metal foil. Each of the two covering layers 24 is assigned a resistance heating ply 22, as already described with reference to FIG. 3. The design of the heating layer 14″ which is third from the top differs from this design of the heating layer 14′ which is second from the top in that, instead of two resistance heating plies 22, only one is arranged between the two covering layers 24 and therefore the two covering layers 24 are heated. As regards the functioning of the heating device 5 according to FIG. 4, reference is made to the functioning of the heating device 5 according to FIG. 3 which is different with the exception of the different number of air-throughflow layers 10 used or the heating layers assigned in this case.

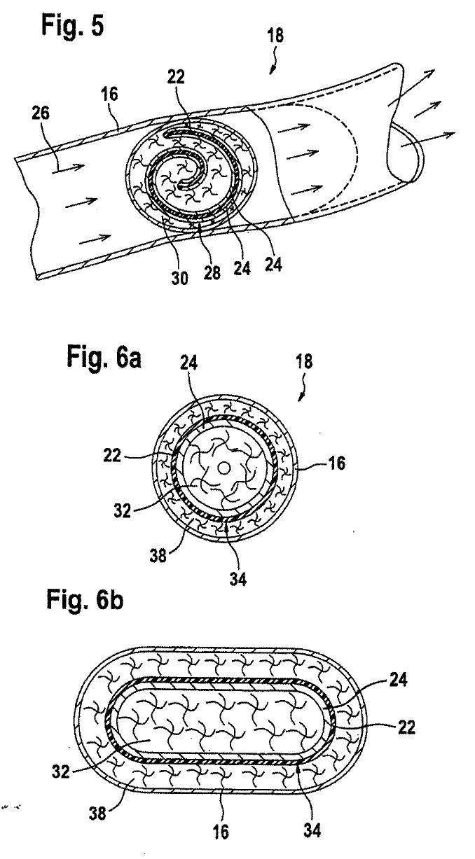

FIG. 5 shows, in a schematic perspective illustration, the heating device 5 according to a third embodiment, which is arranged within a housing 16 designed as a tubular air duct. Within said housing 16, a blower (not illustrated), by means of which an air flow illustrated by arrows 26 is generated, is provided upstream of the sandwich 18, explained in more detail further on. The sandwich 18 essentially comprises a heating layer 28 and an air-throughflow layer 30 and is coiled up to form a worm of approximately circular cross section. The air-throughflow layer 30 in this case is designed in such a manner that it completely surrounds the heating layer 28 circumferentially. The heating layer 28 comprises, in turn, a resistance heating ply 22 which is covered on each of its two wide sides by a covering layer 24 preferably composed of a metal foil or a metal sheet. It is clear that, here too, central portions of the air-throughflow layer 30 are flanked on their two wide sides by the heating layer 28. Accordingly, high heating of the air flow is possible in said regions. By contrast, the portions of the air-throughflow layer 30 that lie on the outside circumferentially or are adjacent to the wall of the housing 16 are flanked only on one wide side—namely the inner—by the heating layer 28. Accordingly, that part of the air flow which flows through the outer regions of the air-throughflow layer 30, which regions are adjacent to the wall of the housing 16, are heated to a lesser extent than the above-described inner parts of the overall air flow. As a result, this also gives rise, as seen in cross section, to a layering of the overall air flow, with a central part air flow being heated to a greater extent than an outer part of the air flow. It is clear that the air-throughflow layer 30 may also comprise a plurality of portions which have a different flow resistance. In addition, a cooling layer may also be provided here instead of or in addition to the heating layer 28.

FIG. 6a shows, in a schematic cross-sectional view, the heating device 5 according to a fourth embodiment, in which the sandwich 18 is arranged within a housing designed as a tubular air duct 16. The sandwich 18 in this case comprises a central air-throughflow layer 32 of approximately circular overall cross section, which is surrounded circumferentially by a heating layer 34. The heating layer 34 comprises a covering layer 24 composed of metal sheet or metal foil, which layer adjoins the outer surface area of the air-throughflow layer 32 and is again surrounded on the outside by a resistance heating ply 22. On the outer circumference of the heating layer 34, an outer air-throughflow layer 38 is provided which runs between the heating layer 34 and the wall of the housing 16. It is also apparent here that the centrally arranged air-throughflow layer 32 can be heated to a greater extent than the outer air-throughflow layer 38. The central air-throughflow layer 32 and the outer air-throughflow layer 38 here too may also offer a different flow resistance to the air flow flowing through.

FIG. 6b illustrates the heating device 5 according to FIG. 6a in accordance with a further embodiment which differs from the embodiment according to FIG. 6a essentially only in that, in the present case, an oval cross section of the sandwich 18 has been selected. Accordingly, in FIG. 6b, identical components are designated by the same reference numbers as in FIG. 6a.

The sandwich 18 according to FIGS. 5, 6a and 6b can be expanded radially as desired, depending on the diameter of the housing 16. The length of the sandwich 18 can also be configured as desired.

FIGS. 7a and 7b illustrate, respectively in a schematic top view and a schematic sectional view along the line VIIb-VIIb in FIG. 7a, one possible structure 40 of the air-throughflow layers 10, 12, 30, 32, 38. The structure 40 here comprises a “knitted spacer structure” which comprises in each case on its upper and lower wide side a covering layer in the form of a honeycomb structure 42. Between the upper and lower covering layer 42 extend a multiplicity of spacer threads or spacer webs 44 which extend essentially transversely with respect to the two covering layers 42. By virtue of the orientation of and the distance between the spacer threads or spacer webs 42, the flow resistance of the structure 40 can be varied here and, accordingly, the flow velocity of the air flow passing through the structure 40 can be established. In the present exemplary embodiment, the spacer threads or spacer webs 44 may be produced, in particular, from a plastic. In a special embodiment, instead of the spacer threads or spacer webs 44, use is also made of spacer wires or the like which are preferably produced from a readily heat-conductive metal, such as from an aluminum alloy or a copper alloy. Metal wires of this type have the advantage, as compared with plastic threads, that they can additionally discharge the heat or cold—generated by means of the heating and/or cooling layer 14, 28, 34—particularly effectively to the turbulent or diffuse flow of the air flow passing through the air-throughflow layer 10, 12, 30, 32, 38.

FIGS. 8a and 8b illustrate respectively a schematic top view and a schematic side view along the line VlIIb-VIIIb in FIG. 8a of the structure 40′ of the air-throughflow layers 10, 12, 30, 32, 38 according to a further embodiment. In this case, spacer webs or spacer wires 46 run perpendicularly with respect to the two wide sides of the structure 40′. As can be seen from FIG. 8a, the spacer webs or spacer wires 46 are arranged in series with one another.

FIGS. 9a and 9b illustrate respectively, in a schematic plan view or schematic sectional view along the line IXb-IXb in FIG. 9a, a further structure 40″ in which spacer webs 48 of essentially rectangular cross section extend between the two wide sides of the structure 40. As shown by comparison with FIG. 10 which shows, in top view, the arrangement of the spacer webs 48 in an alternative configuration, it becomes clear that the webs may be oriented longitudinally, transversely or else obliquely with respect to the direction of flow of the air flow flowing through the air-throughflow layer.

Furthermore, FIGS. 11a and 11b show respectively, in a schematic top view and in a sectional view along the line XIb-XIb in FIG. 11a, a structure 40′″ in which the spacer threads, spacer webs or spacer wires are arranged so as to be unorientated with respect to one another in the manner of a wool. The spacer threads, spacer webs or spacer wires in this case may be produced, in particular, from a plastic or else from a metal.

The upper region of the backrest 2 and the head restraint 3 which is held in a height-adjustable manner thereon can be seen in a schematic perspective illustration in FIG. 12, with the heating and/or cooling device 5 being arranged below the seat cover 7. Accordingly, of the heating and/or cooling device 5 essentially only the air discharge opening 6 can be seen which extends on the front side 8, which faces the seat occupant, and in the vicinity of the end side 9, of the backrest 2. The air discharge opening 6 runs here at least over approximately one third of the width b of the backrest 2 of the vehicle seat. The width b of the backrest 2 is understood as meaning the width which the backrest 2 measures in the vicinity of the seat part 1. In other words, the width b is also understood as meaning approximately the width of the seat part. The air discharge opening is preferably approx. 100 mm to approx. 500 mm in width. In the vertical direction, the air discharge opening preferably extends within a range of approximately 10 mm to approximately 60 mm. In the present exemplary embodiment, the air discharge opening 6 is of approximately rectangular configuration; the air discharge opening 6 may nevertheless also have a different cross-sectional shape, such as, for example, a square, a circle, an ellipse, a polygon or the like. In the configuration shown, the air supply device 4 or, in particular, the heating and/or cooling device 5 is also dimensioned in such a manner that said device can be arranged within the guide rods 11 of the head restraint 3. The blower 20, which is merely indicated schematically, is arranged on the rear side of the heating and/or cooling device 5, which side faces away from the front side 8 of the backrest 2 or faces away from the air discharge opening 6. The air inlet opening of the blower 20 may be provided here on the rear side of the backrest 2. On the front side 8 of the backrest 2, part of a seat area 13 can be seen, the seat area extending in a central, lower region of the backrest 2 and being delimited laterally by the seams 15 and upwardly by the seam 17. It is apparent that, in the present exemplary embodiment, the air discharge opening 6 extends at least approximately over the width of said seat area 13. In addition, it can be seen that the heating and/or cooling device 5 or, in particular, the housing 16 with the sandwich 18 is of slightly curved design—as seen in the longitudinal direction of the vehicle—and is therefore adapted to the shape of the end side 9 of the backrest 2.

FIGS. 13a and 13b illustrate respectively, in a schematic perspective view and in a sectional view along the line XIIIb-XIIIb in FIG. 13a, the air supply device 4 according to a further embodiment of the invention. It can be seen here in particular from FIG. 13a that the heating and/or cooling device or the housing 16 with the sandwich 18 is dimensioned to be longer—as seen in the width direction of the backrest 2—than the distance between the two guide rods 11 of the head restraint 3. In other words, in the present exemplary embodiment, the guide rods 11 pass through the housing 16 or the sandwich 18 in the region of two correspondingly dimensioned recesses. When viewed together with FIG. 13b, in particular the cross section of the air supply device 4 with the housing 16, the sandwich 18 and the blower 20 can be seen. In this case, the air supply device 4 extends—as viewed in cross section—from the air discharge opening 6 in the vicinity of the upper end side 9 of the backrest 2 toward the rear. An inlet opening 21 of the blower 20 is provided on the rear side of the backrest 2 in an arrangement offset downward in relation to the air discharge opening 6. In the present exemplary embodiment, the sandwich 18, which is accommodated within the housing 16 and is arranged at a distance from the blower 21 on the delivery side thereof, is configured in accordance with the design according to FIG. 3 from three air-throughflow layers 10, 12 and heating and/or cooling layers 14 arranged in between.

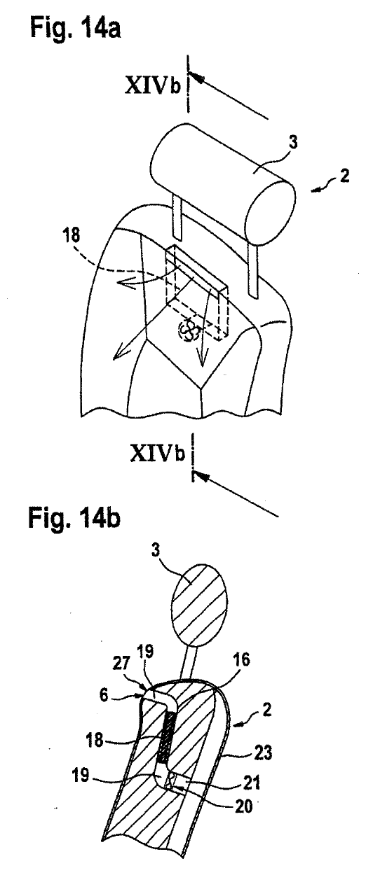

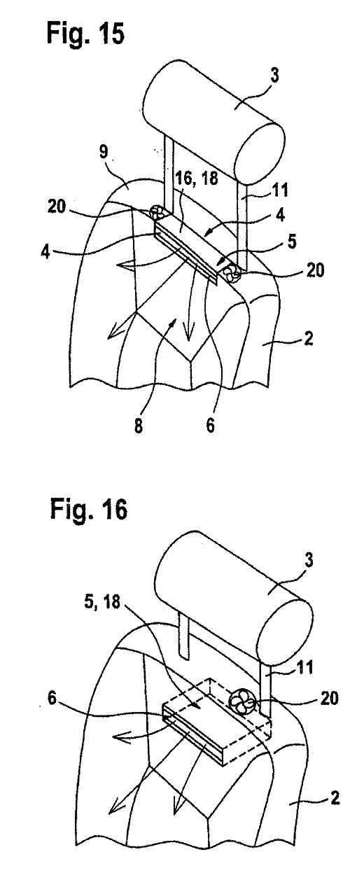

FIGS. 14a and 14b illustrate respectively, in a schematic perspective illustration and in a schematic sectional illustration along the line XIVb-XIVb in FIG. 14a, the backrest 2 with an air supply device 4, which is integrated therein, according to a further embodiment. This air supply device differs from the previous embodiments essentially in that the sandwich 18 is arranged approximately vertically. Accordingly, a bent portion 17 of the housing 16 is provided in the upper region thereof in the region of the air discharge opening 6. The blower 20, which is arranged in the vicinity of a further bent portion 19 of the housing 16, can be seen at the lower end of the housing 16. In the present exemplary embodiment, the blower 20 is designed as an axial fan; however, a radial fan would likewise also be conceivable. In the present exemplary embodiment, the air inlet opening 21 of the blower 20 is covered by a “backrest clamping part” 23 which forms the rear side of the backrest 2. Accordingly, the air is sucked up from the space directly in front of the backrest clamping part 23. The air discharge opening 6 may be covered by an outlet grill 27, outlet net or the like which ensures an additional homogenization and evening out of the air flow being discharged from the sandwich 18. A further embodiment of the air supply device is illustrated in a schematic perspective view in FIG. 15, in which the sandwich 18 and the housing 16 surrounding the latter are dimensioned in such a manner that said housing can be positioned on the upper end side 9 within the backrest 2 and in front of the guide rails 11 of the head restraint 3. In other words, the heating and/or cooling device 5 or the sandwich 18 is/are configured to be narrow enough for it to fit into the space between the guide rods 11 of the head restraint 3 and the front side 8 of the backrest 2. At the side of the heating and/or cooling device 5 or at the side of the sandwich 18, the air supply device 4 in each case comprises a blower 20 which, in the present exemplary embodiment, is designed as an axial fan and the respective air inlet opening of which is arranged on the upper end side 9 of the backrest 2.

Finally, FIG. 16 illustrates, in a schematic perspective view, a further embodiment of the air supply device 4, in which the air discharge opening 6 is arranged somewhat lower down than in the previous exemplary embodiments. The heating and/or cooling device 5 with the sandwich 18 is of essentially approximately rectangular design and is arranged between the two guide rods 11 of the head restraint 3. A blower 20 which is designed as an axial fan and the air inlet opening of which is arranged on the rear side of the backrest 2 can be seen at the rear end of the sandwich 18. Overall, the air supply device 6 with the heating and/or cooling device 5 and the blower 20 arranged there behind is, however, only designed to be sufficiently wide for it to be able to be arranged within the backrest.

1-29. (canceled)

30. A motor vehicle seat for a closed motor vehicle having an air supply device for supplying a head, neck and shoulder region of a seat occupant with warm air, said air supply device comprising:
an air discharge opening, and
a heating, cooling, or heating and cooling device for heating and/or cooling an air flow which can emerge via the air discharge opening on a side of a seat that faces the seat occupant,
wherein the air discharge opening extends at least over approximately one third of a width of a backrest of the vehicle seat,
wherein the heating, cooling, or heating and cooling device includes a sandwich with at least one heating, cooling, or heating and cooling layer and at least one air-throughflow layer, and
wherein the air-throughflow layer has a structure by which the air flow can be converted into a turbulent or diffuse flow.

31. The motor vehicle seat as claimed in claim 30, wherein the air discharge opening extends at least approximately over the width of a seat area of the backrest.

32. The motor vehicle seat as claimed in claim 30, wherein the side that faces the seat occupant is a front side, and wherein the air discharge opening is arranged in the vicinity of an upper end side of the backrest.

33. The motor vehicle seat as claimed in claim 30, wherein the air discharge opening is arranged on a front side of a head restraint, which front side faces the seat occupant.

34. The motor vehicle seat as claimed in claim 33, wherein the air discharge opening extends at least approximately over the width of the head restraint.

35. The motor vehicle seat as claimed in claim 30, wherein the air supply device is integratable as a preassembled installation module into the vehicle seat.

36. The motor vehicle seat as claimed in claim 30, wherein the structure of the air-throughflow layer comprises a multiplicity of spacer threads, spacer webs, or spacer wires.

37. The motor vehicle seat as claimed in claim 30, wherein the structure of the air-throughflow layer is a knitted structure.

38. The motor vehicle seat as claimed in claim 30, wherein the structure of the air-throughflow layer is a woven structure.

39. The motor vehicle seat as claimed in claim 30, wherein the structure of the air-throughflow layer is a braided structure.

40. The motor vehicle seat as claimed in claim 30, wherein the structure of the air-throughflow layer has a disordered configuration.

41. The motor vehicle seat as claimed in claim 40, wherein the structure is a wool.

42. The motor vehicle seat as claimed in claim 40, wherein the structure is a metal wool.

43. The motor vehicle seat as claimed in claim 30, wherein the air-throughflow layer is delimited on each of two wide sides by a covering layer.

44. The motor vehicle seat as claimed in claim 30, wherein the layers have essentially honeycomb structures.

45. The motor vehicle seat as claimed in claim 30, wherein the structure of the air-throughflow layer is produced from a plastic.

46. The motor vehicle seat as claimed in claim 30, wherein the structure of the air-throughflow layer is produced from a readily heat-conductive, cold-conductive, or heat and cold-conductive metal.

47. The motor vehicle seat as claimed in claim 30, wherein the structure of the air-throughflow layer is designed to be slightly deformable.

48. The motor vehicle seat as claimed in claim 30, wherein the at least one heating, cooling, or heating and cooling layer is assigned a readily heat- or cold-conductive covering layer arranged between the heating, cooling, or heating and cooling layer and the air-throughflow layer.

49. The motor vehicle seat as claimed in claim 30, wherein at least three air-throughflow layers are provided, and wherein a heating, cooling, or heating and cooling layer is arranged in each case between middle and outer air-throughflow layers.

50. The motor vehicle seat as claimed in claim 49, wherein the structure of the middle air-throughflow layer has a higher flow resistance than the structure of the outer air-throughflow layers.

51. The motor vehicle seat as claimed in claim 30, wherein the sandwich is coiled.

52. The motor vehicle seat as claimed in claim 30, wherein the air-throughflow layer is surrounded circumferentially by the heating, cooling, or heating and cooling layer.

53. The motor vehicle seat as claimed in claim 52, wherein the heating, cooling or heating and cooling layer is surrounded circumferentially by a further air-throughflow layer.

54. The motor vehicle seat as claimed in claim 53, wherein the structure of the inner air-throughflow layer has a higher flow resistance than the structure of the outer air-throughflow layer.

55. The motor vehicle seat as claimed in claim 30, wherein the air supply device has at least one blower arranged, as seen in the width direction of the vehicle seat, approximately in the middle of the heating, cooling, or heating and cooling device.

56. The motor vehicle seat as claimed in claim 30, wherein the air supply device comprises at least one blower arranged on a rear side of the heating, cooling, or heating and cooling device that faces away from the front side of the seat.

57. The motor vehicle seat as claimed in claim 30, wherein the heating, cooling, or heating and cooling device is enlarged in an approximately V-shaped manner from a blower as far as the air discharge opening.

58. The motor vehicle seat as claimed in claim 30, wherein the air supply device comprises at least one blower that corresponds in its thickness at least approximately to a thickness of the heating, cooling, or heating and cooling device, and wherein the blower and the heating, cooling, or heating and cooling device are arranged at least approximately in a common plane.

59. The motor vehicle seat as claimed in claim 30, wherein the air discharge opening is covered by an outlet grill or outlet net.

60. The motor vehicle seat as claimed in claim 30, wherein the air supply device can be fitted as a retrofittable module in the vicinity of an upper end side of the backrest.
